(19) United States
(12) Patent Application Publication
(10) Pub. No.: US 2026/0056338 A1
(43) Pub. Date: Feb. 26, 2026

(54) SEABED SEISMIC PROCESSING FOR ELASTIC FULL WAVEFORM INVERSION

(71) Applicant: Schlumberger Technology Corporation, Sugar Land, TX (US)

(72) Inventors: Claudio Bagaini, Crawley (GB); Daniele Boiero, Houston, TX (US); James Rickett, Crawley (GB); Massimiliano Vassallo, Crawley (GB); Qiang Guo, Crawley (GB)

(73) Assignee: Schlumberger Technology Corporation, Sugar Land, TX (US)

(21) Appl. No.: 19/225,895

(22) Filed: Jun. 2, 2025

Related U.S. Application Data
(60) Provisional application No. 63/654,199, filed on May 31, 2024.

(51) Int. Cl. G01V 1/28

(52) U.S. Cl. CPC G01V 1/282; G01V 2210/1297; G01V 2210/1427; G01V 2210/66

(57) ABSTRACT

A method of modeling a subsurface area of a seabed using fewer seismic sensors than a seismic sensors that generate sufficient data to permit a desired model of the subsurface area. Seismic datasets are received from the fewer seismic sensors. The fewer seismic sensors are located at points defined in relation to the seabed. Boundary conditions of a seismic wavefield at a fluid-solid interface between the seabed and water above the seabed are identified. An estimation, from the seismic datasets and the boundary conditions, is made of one or more virtual datasets. Each of the virtual datasets includes corresponding estimated data for additional points defined in relation to the seabed. The points and the additional points, combined, are sufficient to permit the desired model of the subsurface area. A subsurface model of the subsurface area is generated by modeling the subsurface area using the seismic datasets and the virtual datasets.

### CROSS-REFERENCE TO RELATED APPLICATIONS

This application claims priority to U.S. Provisional Patent Application No. 63/654,199, filed May 31, 2024, the entirety of which is hereby incorporated by reference.

### BACKGROUND

A reservoir can be a subsurface formation that can be characterized at least in part by its porosity and fluid permeability. As an example, a reservoir may be part of a basin, such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

### SUMMARY

One or more embodiments provide for a method of modeling a subsurface area of a seabed using fewer seismic sensors than a number of seismic sensors that generate sufficient data to permit a desired model of the subsurface area. The method includes receiving a number of seismic datasets from the fewer seismic sensors, the fewer seismic sensors located at a number of points defined in relation to the seabed. The method also includes identifying boundary conditions of a seismic wavefield at a fluid-solid interface between the seabed and water above the seabed. The method also includes estimating, from the number of seismic datasets and the boundary conditions, a number of virtual datasets. Each of the number of virtual datasets includes corresponding estimated data for an additional number of points defined in relation to the seabed. The number of points and the additional number of points, combined, are sufficient to permit the desired model of the subsurface area. The method also includes generating a subsurface model of the subsurface area by modeling the subsurface area using the number of seismic datasets and the number of virtual datasets.

One or more embodiments also provide for a system for modeling a subsurface area of a seabed using fewer seismic sensors than a number of seismic sensors that generate sufficient data to permit a desired model of the subsurface area. The system includes a computer processor and a number of seismic sensors. The number of seismic sensors includes the fewer seismic sensors, and wherein the number of seismic sensors are located at a number of points defined in relation to the seabed. The system also includes a data repository in communication with the computer processor and storing a number of seismic datasets. The data repository also stores boundary conditions of a seismic wavefield at a fluid-solid interface between the seabed and water above the seabed. The data repository also stores a number of virtual datasets wherein each of the number of virtual datasets includes corresponding estimated data for an additional number of points defined in relation to the seabed. The data repository also stores a subsurface model. The system also includes a server controller executable by the computer processor to receive the number of seismic datasets from the number of seismic sensors. The server controller is further executable by the computer processor to identify the boundary conditions. The server controller is further executable by the computer processor to estimate, from the number of seismic datasets and the boundary conditions, the number of virtual datasets. The number of points and the additional number of points, combined, are sufficient to permit the desired model of the subsurface area. The server controller is further executable by the computer processor to generate the subsurface model of the subsurface area by modeling the subsurface area using the number of seismic datasets and the number of virtual datasets.

Other aspects of one or more embodiments will be apparent from the following description and the appended claims.

### BRIEF DESCRIPTION OF DRAWINGS

FIG. 1 depicts an example computing system, in accordance with one or more embodiments.

FIG. 2 illustrates a survey operation being performed by a survey tool to measure properties of the subterranean formation, in accordance with one or more embodiments.

FIG. 3 illustrates a drilling operation being performed by drilling tools advanced into subterranean formations to form wellbore, in accordance with one or more embodiments.

FIG. 4 illustrates a wireline operation being performed by a wireline tool into the wellbore of FIG. 3, in accordance with one or more embodiments.

FIG. 5 illustrates a production operation into a completed wellbore for drawing fluid from the downhole reservoirs into surface facilities, in accordance with one or more embodiments.

FIG. 6 illustrates a schematic view of an oilfield having data acquisition tools for collecting data of a subterranean formation, in accordance with one or more embodiments.

FIG. 7 illustrates an oilfield for performing production operations, in accordance with one or more embodiments.

FIG. 8 is a flowchart illustrating generation of virtual datasets, in accordance with one or more embodiments.

FIG. 9.1, FIG. 9.2, and FIG. 9.3 illustrate a schematic representation of one trace of a dataset created using a first group of measurements, in accordance with one or more embodiments.

FIG. 10 shows a model for the creation of a synthetic dataset, in accordance with one or more embodiments.

FIG. 11.1, FIG. 11.2, and FIG. 11.3 illustrates acoustic upward extrapolation, in accordance with one or more embodiments.

FIG. 12.1, FIG. 12.2, and FIG. 12.3 illustrates a horizontal gradient of the pressure just above the seabed, in accordance with one or more embodiments.

FIG. 13 illustrates creation of a dataset of a second group of data using horizontal pressure gradients, in accordance with one or more embodiments.

FIG. 14.1 illustrates a half-space experiment, in accordance with one or more embodiments.

FIG. 14.2 illustrates elastic properties of the two media, in accordance with one or more embodiments.

FIG. 15.1, FIG. 15.2, FIG. 15.3, FIG. 15.4, and FIG. 15.5 are illustrations of the accuracy of acoustic modeling for the model shown in FIG. 14.1, in accordance with one or more embodiments.

FIG. 16 illustrates a schematic representation of the lateral invariance assumption applied to ocean bottom seismometer data sparsely sampled on receiver sensors, in accordance with one or more embodiments.

FIG. 17 shows a system for seabed seismic processing for elastic full waveform inversion, in accordance with one or more embodiments.

FIG. 18 shows a method for seabed seismic processing for elastic full waveform inversion, in accordance with one or more embodiments.

Like elements in the various figures are denoted by like reference numerals for consistency.

### DETAILED DESCRIPTION

One or more embodiments are directed to methods and devices for solving the technical problem of modeling a subsurface area when insufficient data exists to model the subsurface area to a desired degree of accuracy. Modeling techniques, such as full waveform inversion, may use seismic data to characterize a subsurface area. For example, the presence or absence of subsurface formations (faults, cracks, different layers of different types of stone or soil, etc.) may be of interest because the subsurface formations may change how a drill operator may drill in the subsurface area. In another example, the presence or absence of subsurface hydrocarbon reserves may influence where or how a drill operator may drill in the subsurface area.

Modeling techniques may require a tremendous amount of data in order to model the subsurface area to a desired degree of accuracy. Obtaining the desired amount of data may involve many seismic sensors and seismic sound emitters. However, there may be impediments to placing or obtaining the desired number of seismic sensors and emitters. For example, in an undersea exploration environment, the number of available sensors may be limited by the harsh conditions imposed by operating in the undersea environment. Thus, in many cases, less than the desired amount of data is available. Thus, the technical problem described arises: How to model the subsurface area when less than the desired amount of seismic data is available.

The technical solution to the technical problem described above involves generating a number of virtual datasets. The virtual datasets supplement the available real datasets. The virtual datasets are generated from the real datasets based on the propagation of the measured seismic waves to additional locations that are nearby the locations where the real seismic sensors are located.

In particular, the virtual datasets may include one or more types of datasets useful in modeling the subsurface area. Thus, the virtual datasets may include one, or a combination of, a) pressure and particle velocity estimates and corresponding spatial derivatives thereof in a column in the water, b) a dense dataset comprising additional seismic datasets representing estimated data taken by additional virtual seismic sensors, and c) P and S wavefield potentials below the seabed taken by further additional virtual seismic sensors.

Stated differently, the real datasets may be used to derive the above information, which in turn serve as virtual datasets at additional locations than the locations at which real data is measured. Combined, the virtual datasets and real datasets establish a sufficient amount of data to model the subsurface area to a desired degree of accuracy.

Once the subsurface model is generated, the subsurface model can be used to control drilling operations. For example, the subsurface model may be used to control drilling parameters (e.g., drilling speed, drilling location, drill bit type, drilling angle, etc.) in order to drill a wellbore into the subsurface area. Thus, one or more embodiments may improve the efficiency and effectiveness of natural resource exploration.

Attention is now turned to the figures. Attention is first turned to computing systems for implementing one or more embodiments. FIG. 1 depicts an example computing system (100A) in accordance with some embodiments. The computing system (100A) can be an individual computer system (101A) or an arrangement of distributed computer systems. The computer system (101A) includes one or more geosciences analysis modules (102A) that are configured to perform various tasks according to some embodiments, such as one or more methods disclosed herein. To perform these various tasks, geosciences analysis module (102) executes independently, or in coordination with, one or more processors (104A), which is (or are) connected to one or more storage media (106A). The processor(s) (104) is (or are) also connected to a network interface (108A) to allow the computer system (101A) to communicate over a data network (110A) with one or more additional computer systems and/or computing systems, such as (101B), (101C), and/or (101D) (note that computer systems (101B), (101C) and/or (101D) may or may not share the same architecture as computer system (10A), and may be located in different physical locations, e.g., computer systems (101A) and (101B) may be on a ship underway on the ocean, while in communication with one or more computer systems such as (101C) and/or (101D) that are located in one or more data centers on shore, other ships, and/or located in varying countries on different continents). Note that data network (110A) may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media (106A) can be implemented as one or more computer-readable or machine-readable storage media. Note that while in the example embodiment of FIG. 1 storage media (106A) is depicted as within computer system (10A), in some embodiments, storage media (106A) may be distributed within and/or across multiple internal and/or external enclosures of computing system (101A) and/or additional computing systems. Storage media (106A) may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays, or any other type of optical media; or other types of storage devices. Note that the instructions discussed above can be provided on one computer-readable or machine-readable storage medium, or can be provided on multiple computer-readable or machine-readable storage media distributed in a large system having possibly plural nodes and/or non-transitory storage means. Such computer-readable or machine-readable storage medium or media are considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Software instructions in the form of computer-readable program code to perform embodiments may be stored, in whole or in part, temporarily or permanently, on a non-transitory computer-readable medium such as a solid state drive (SSD), compact disk (CD), digital video disk (DVD), storage device, a diskette, a tape, flash memory, physical memory, or any other computer-readable storage medium. Specifically, the software instructions may correspond to computer-readable program code that, when executed by the computer processor(s), is configured to perform one or more embodiments, which may include transmitting, receiving, presenting, and displaying data and messages described in the other figures of the disclosure.

The computing system of FIG. 1 may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

It should be appreciated that computer system (101A) is one example of a computing system, and that computer system (101A) may have more or fewer components than shown, may combine additional components not depicted in the example embodiment of FIG. 1, and/or computer system (101A) may have a different configuration or arrangement of the components depicted in FIG. 1. The various components shown in FIG. 1 may be implemented in hardware, software, or a combination of both, hardware and software, including one or more signal processing and/or application specific integrated circuits.

It should also be appreciated that while no user input/output peripherals are illustrated with respect to computer systems (101A), (101B), (101C), and (101D), many embodiments of computing system (100A) include computer systems with keyboards, mice, touch screens, displays, etc. Some computer systems in use in computing system (100A) may be desktop workstations, laptops, tablet computers, smartphones, server computers, etc.

Further, the steps in the processing methods described herein may be implemented by running one or more functional modules in an information processing apparatus such as general purpose processors or application specific chips, such as ASICs, FPGAs, PLDs, or other appropriate devices. These modules, combinations of these modules, and/or their combination with general hardware are included within one or more embodiments.

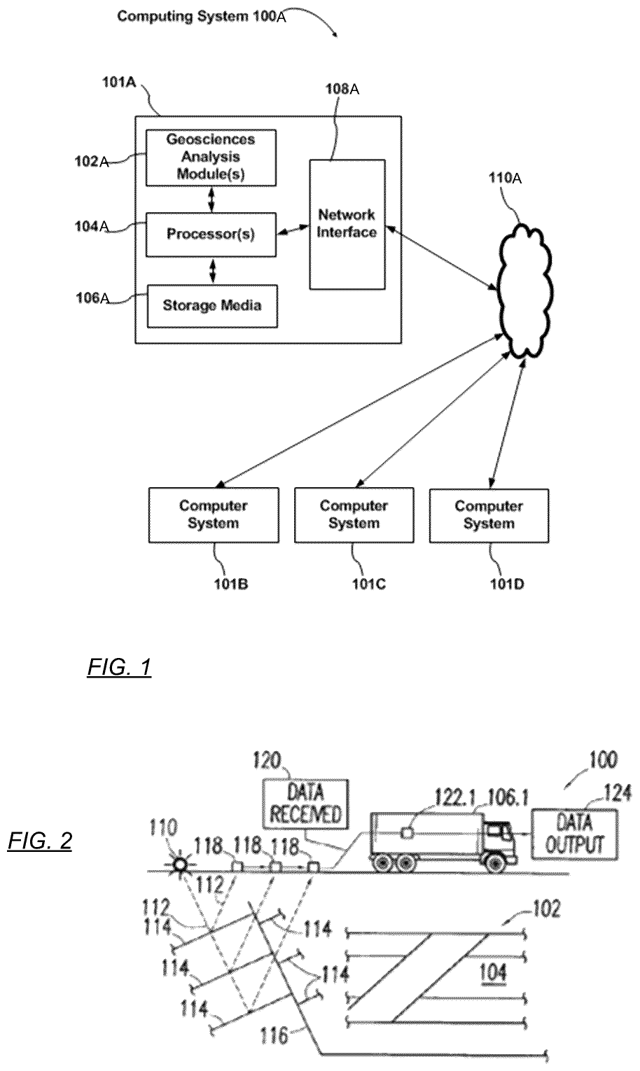

FIG. 2 through FIG. 5 illustrate simplified, schematic views of oilfield (100) having a subterranean formation (102) containing reservoir (104) therein in accordance with implementations of various technologies and techniques described herein.

FIG. 2 illustrates a survey operation being performed by a survey tool, such as seismic truck (106.1), to measure properties of the subterranean formation. The survey operation is a seismic survey operation for producing sound vibrations. In FIG. 2, one such sound vibration, e.g., sound vibration (112) generated by source (110), reflects off horizons (114) in earth formation (116). A set of sound vibrations is received by sensors, such as geophone-receivers (118), situated on the Earth's surface. The data received (120) is provided as input data to a computer (122.1) of a seismic truck (106.1), and responsive to the input data, computer (122.1) generates seismic data output (124). This seismic data output may be stored, transmitted, or further processed as desired, for example, by data reduction.

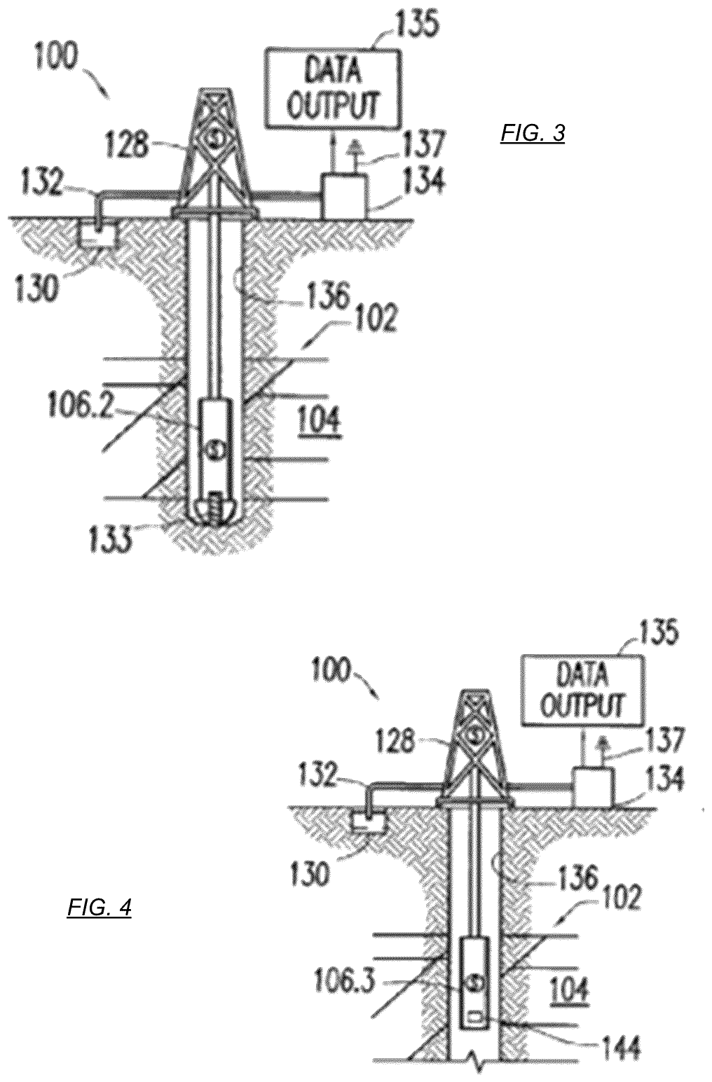

FIG. 3 illustrates a drilling operation being performed by drilling tools (106.2) suspended by rig (128) and advanced into subterranean formations (102) to form wellbore (136). Mud pit (130) is used to draw drilling mud into the drilling tools via flow line (132) for circulating drilling mud down through the drilling tools, then up wellbore (136) and back to the surface. The drilling mud may be filtered and returned to the mud pit. A circulating system may be used for storing, controlling, or filtering the flowing drilling mud. The drilling tools are advanced into subterranean formations (102) to reach reservoir (104). Each well may target one or more reservoirs. The drilling tools are adapted for measuring downhole properties using logging while drilling tools. The logging while drilling tools may also be adapted for taking core sample (133) as shown.

Computer facilities may be positioned at various locations about the oilfield (100) (e.g., the surface unit (134) and/or at remote locations. Surface unit (134) may be used to communicate with the drilling tools and/or offsite operations, as well as with other surface or downhole sensors. Surface unit (134) is capable of communicating with the drilling tools to send commands to the drilling tools, and to receive data therefrom. Surface unit (134) may also collect data generated during the drilling operation and produce data output (135), which may then be stored or transmitted.

Sensors (S), such as gauges, may be positioned about oilfield (100) to collect data relating to various oilfield operations as described previously. As shown, sensors (S) is positioned in one or more locations in the drilling tools and/or at rig (128) to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools (106.2) may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit (134). The bottom hole assembly further includes drill collars for performing various other measurement functions.

The bottom hole assembly may include a communication subassembly that communicates with surface unit (134). The communication subassembly is adapted to send signals to and receive signals from the surface using a communications channel, such as mud pulse telemetry, electromagnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic, or other telemetry systems.

The wellbore may be drilled according to a drilling plan that is established prior to drilling. The drilling plan may be set forth equipment, pressures, trajectories, and/or other parameters that define the drilling process for the well site. The drilling operation may then be performed according to the drilling plan. However, as information is gathered, the drilling operation may deviate from the drilling plan. Additionally, as drilling or other operations are performed, the subsurface conditions may change. The earth model may also be adjusted as new information is collected.

The data gathered by sensors (S) may be collected by surface unit (134) and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit (134) may include transceiver (137) to allow communications between surface unit (134 and various portions of the oilfield (100) or other locations. Surface unit (134) may also be provided with or functionally connected to one or more controllers (not shown) for actuating mechanisms at oilfield (100). Surface unit (134) may then send command signals to oilfield (100) in response to data received. Surface unit (134) may receive commands via transceiver (137) or may itself execute commands to the controller. A processor may be provided to analyze the data (locally or remotely), make the decisions and/or actuate the controller. In this manner, oilfield (100) may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 4 illustrates a wireline operation being performed by wireline tool (106.3) suspended by rig (128) and into wellbore (136) of FIG. 3. Wireline tool (106.3) is adapted for deployment into wellbore (136), for generating well logs, performing downhole tests, and/or collecting samples. Wireline tool (106.3 may be used to provide another method and apparatus for performing a seismic survey operation. Wireline tool (106.3) may, for example, have an explosive, radioactive, electrical, or acoustic energy source (144) that sends and/or receives electrical signals to surrounding subterranean formations (102) and fluids therein.

Wireline tool (106.3) may be operatively connected to, for example, geophones (118) and a computer (122.1) of a seismic truck (106.1) of FIG. 2. Wireline tool (106.3) may also provide data to surface unit (134). Surface unit (134) may collect data generated during the wireline operation and may produce data output (135) that may be stored or transmitted. Wireline tool (106.3) may be positioned at various depths in the wellbore (136) to provide a survey or other information relating to the subterranean formation (102).

Sensors (S), such as gauges, may be positioned about oilfield (100) to collect data relating to various field operations as described previously. As shown, sensors (S) is positioned in wireline tool (106.3) to measure downhole parameters which relate to, for example porosity, permeability, fluid composition, and/or other parameters of the field operation.

FIG. 5 illustrates a production operation being performed by production tool (106.4) deployed from a production unit or Christmas tree (129) and into completed wellbore (136) for drawing fluid from the downhole reservoirs into surface facilities (142). The fluid flows from reservoir (104) through perforations in the casing (not shown) and into production tool (106.4) in wellbore (136) and to surface facilities (142) via gathering network (146).

Sensors (S), such as gauges, may be positioned about oilfield (100) to collect data relating to various field operations as described previously. As shown, the sensors (S) may be positioned in production tool (106.4) or associated equipment, such as Christmas tree (129), gathering network (146), surface facility (142), and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the well sites for selectively collecting downhole fluids from the well site(s).

While FIGS. 1-5 illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIG. 2 through FIG. 5 are intended to provide a brief description of an example of a field usable with oilfield application frameworks. At least part of oilfield (100) may be on land, water, and/or sea. Also, while a single field measured at a single location is depicted, oilfield applications may be utilized with any combination of one or more oilfields, one or more processing facilities, and one or more well sites.

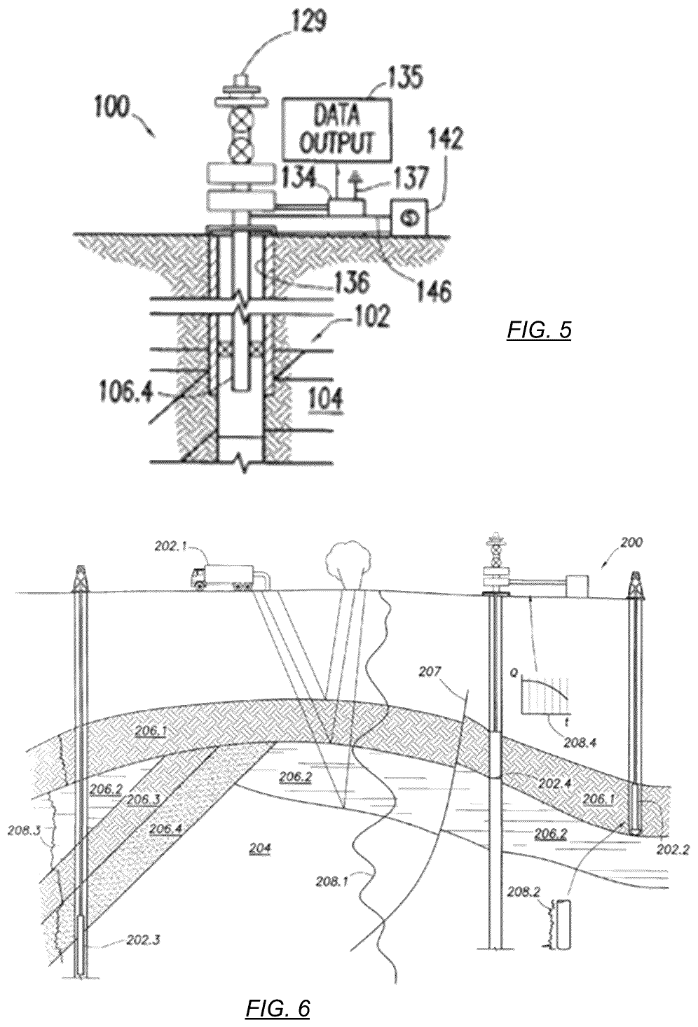

FIG. 6 illustrates a schematic view, partially in a cross section of oilfield (200) having data acquisition tools (202.1), (202.2), (202.3), and (202.4) positioned at various locations along oilfield (200) for collecting data of subterranean formation (204) in accordance with implementations of various technologies and techniques described herein. Data acquisition tools (202.1)-(202.4) may be the same as production tools (106.1)-(106.4) of FIG. 2 through FIG. 5, respectively, or others not depicted. As shown, data acquisition tools (202.1)-(202.4) generate data plots or measurements (208.1)-(208.4), respectively. These data plots are depicted along oilfield (200) to demonstrate the data generated by the various operations.

Data plots (208.1)-(208.3) are examples of static data plots that may be generated by data acquisition tools (202.1)-(202.3), respectively; however, it should be understood that data plots (208.1)-(208.3) may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot (208.1) is a seismic two-way response over a period of time. Static plot (208.2) is core sample data measured from a core sample of the subterranean formation (204). The core sample may be used to provide data, such as a graph of the density, porosity, permeability, or some other physical property of the core sample over the length of the core. Tests for density and viscosity may be performed on the fluids in the core at varying pressures and temperatures. Static data plot (208.3) is a logging trace that may provide a resistivity or other measurement of the formation at various depths.

A production decline curve or graph (208.4) is a dynamic data plot of the fluid flow rate over time. The production decline curve may provide the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean formation (204) has a plurality of geological formations (206.1)-(206.4). As shown, this structure has several formations or layers, including a shale layer (206.1), a carbonate layer (206.2), a shale layer (206.3), and a sand layer (206.4). A fault (207) extends through the shale layer (206.1) and the carbonate layer (206.2). The static data acquisition tools are adapted to take measurements and detect characteristics of the formations.

While a specific subterranean formation with specific geological structures is depicted, it will be appreciated that oilfield (200) may contain a variety of geological structures and/or formations, sometimes having extreme complexity. In some locations, such as below the water line, fluid may occupy pore spaces of the formations. Each of the measurement devices may be used to measure properties of the formations and/or its geological features. While each acquisition tool is shown as being in specific locations in oilfield (200), it will be appreciated that one or more types of measurement may be taken at one or more locations across one or more fields or other locations for comparison and/or analysis.

The data collected from various sources, such as the data acquisition tools of FIG. 6, may then be processed and/or evaluated. Seismic data displayed in static data plot (208.1) from data acquisition tool (202.1) may be used by a geophysicist to determine characteristics of the subterranean formations and features. The core data shown in static plot (208.2) and/or log data from well log (208.3) may be used by a geologist to determine various characteristics of the subterranean formation. The production data from graph (208.4) may be used by the reservoir engineer to determine fluid flow reservoir characteristics. The data analyzed by the geologist, geophysicist, and the reservoir engineer may be analyzed using modeling techniques.

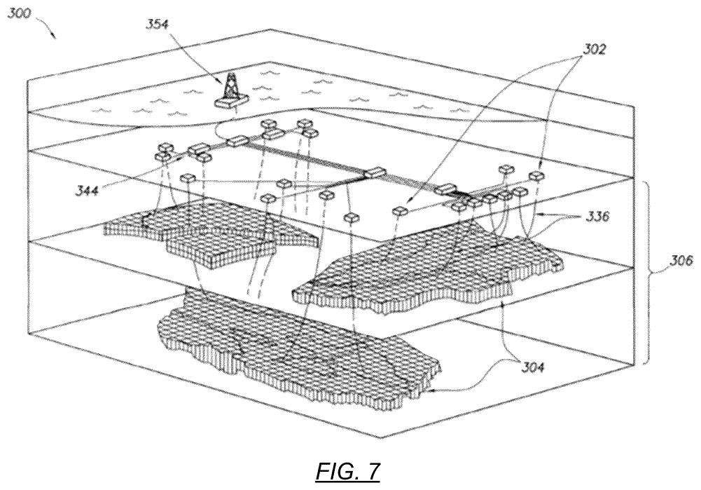

FIG. 7 illustrates an oilfield (300) for performing production operations in accordance with implementations of various technologies and techniques described herein. As shown, the oilfield has a plurality of well sites (302) operatively connected to central processing facility (354). The oilfield configuration of FIG. 7 is not intended to limit the scope of the oilfield application system. At least some of the oilfield may be on land and/or sea. Also, while a single oilfield with a single processing facility and a plurality of well sites is depicted, any combination of one or more oilfields, one or more processing facilities and one or more well sites may be present.

Each well site (302) has equipment that forms wellbore (336) into the earth. The wellbores extend through subterranean formations (306) including reservoirs (304). These reservoirs (304) contain fluids, such as hydrocarbons. The well sites draw fluid from the reservoirs and pass them to the processing facilities via surface networks (344). The surface networks (344) have tubing and control mechanisms for controlling the flow of fluids from the well site to processing facility (354).

Attention is now directed to methods, techniques, and workflows for planning, forecasting, and/or optimizing production related systems (e.g., model selections, reservoir maps, wells, etc.) in accordance with some embodiments. Some operations in the processing procedures, methods, techniques, and workflows disclosed herein may be combined and/or the order of some operations may be changed. Those with skill in the art will recognize that in the geosciences and/or other multi-dimensional data processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system (100A), FIG. 1, and/or through manual control by a user who may make determinations regarding whether a given operation, action, template, or model has become sufficiently accurate.

An ideal offshore seismic dataset may utilize the deployment of seismic sensors at the seabed, in the proximity of the sea surface and anywhere in between the sea surface and the seabed. It would be beneficial if the seismic sources could be activated in a dense grid in the proximity of the sea surface and anywhere in the water column. This acquisition configuration may be unrealistic for economic reasons.

Algorithms that make use of the features of the wave propagation in acoustic and elastic media are therefore useful for creating a dataset that approximates the ideal one without the excessive cost of acquiring it. In an embodiment, a method to obtain such a dataset using multicomponent seismic sensors deployed at the seabed, such as ocean bottom seismometers (OBSs) and/or seismic sensor deployed in the proximity of the sea surface is disclosed.

The groups of virtual datasets that may be created with the disclosed method include pressure and particle velocity estimates and their spatial derivatives in the water column; a dataset denser than the actual one with sources and receivers at the original datum; and P and S wavefield potentials below the seabed. A “P” wave is a fast wave (relative to S waves) that travels through solids, liquids, or gasses and that causes particles to vibrate in the same direction as the direction of wave propagation. “P” waves are also referred to as longitudinal waves. In contrast, an “S” wave is a slower wave (relative to P waves) that travel through solids and cause particles to vibrate in directions perpendicular to the direction of wave propagation.

In a first embodiment of one or more embodiments, the above datasets are obtained from OBS measurements, possibly without other types of measurements. In a second embodiment of one or more embodiments, the datasets are determined using both OBS measurements and seismic measurements made in the water, up to proximity of the sea surface.

The methods to derive the groups of measurements are based on the boundary conditions of the seismic wavefield at the seabed. The boundary conditions at the fluid-solid interface impose that the component of the particle velocity perpendicular to the seabed (i.e., the vertical component in a locally flat seabed) is continuous and that the absolute value of the pressure measured in the acoustic medium coincides with the normal component of the stress tensor at the seabed. If the seawater is a non-viscous fluid, as it is generally assumed, the shear stress is zero at the seabed. The horizontal particle velocity is, in general, discontinuous at the fluid-solid interface. Consequently, the measured horizontal particle velocity cannot be directly used to derive the horizontal gradient of the pressure in water.

The first group of datasets is the pressure and its spatial derivatives in water obtained by applying the two-way acoustic extrapolator to the particle velocity normal to the seabed local plane and to the pressure measured at the seabed. A more concise expression vertical particle velocity may be used instead of the particle velocity normal to the seabed local plane. The two expressions coincide when the seabed is locally flat. The coefficients of the extrapolator depend on the acoustic properties of the seawater in the proximity of the seabed. They may be accurately inferred in OBS surveys using measurements such as hydrostatic pressure, temperature and conductivity and, in some cases, the speed of sound in water taken in the proximity of the seabed. The coefficients of the extrapolator are defined assuming gentle horizontal variations of the medium properties. Although the coefficients are derived in Fourier or in Radon domain, they can be applied in the space-frequency domain as operators with a compact spatial support.

The second dataset determined, described with respect to one or more embodiments is a dataset whose receiver spacing is smaller than in the original data. The Newton's second law dictates that the pressure gradient in water is a density scaled version of the particle acceleration vector in an acoustic medium. Consequently, the horizontal components of the pressure gradient are proportional to the horizontal components of the particle acceleration. The discontinuity of the horizontal particle displacement at the seabed prevents a direct usage of the horizontal ground motion, which is measured by OBSs below the seabed, for this purpose. The measured vertical displacement is continuous at the seabed. It can be used along with the pressure to perform the upward extrapolation using the same two-way acoustic extrapolator used for the estimation of the first group of measurements. In an acoustic medium, the horizontal particle displacement is uniquely determined from the pressure and the vertical particle velocity. Once the horizontal particle displacement in water has been determined, it can be used (along with the water density) to derive the horizontal gradient of the pressure wavefield. Pressure and pressure gradients can then be used as input to the interpolation with gradient methods.

The third group of datasets created with the disclosed method are the up-going and down-going P and S potentials of the wavefield below the seabed. The up-going P potential is a wavefield that does not contain the complexities associated with the mode conversions that may take place in the nearby seabed and is therefore a simpler wavefield for full waveform inversion (FWI) that honors the P propagation without the S propagation.

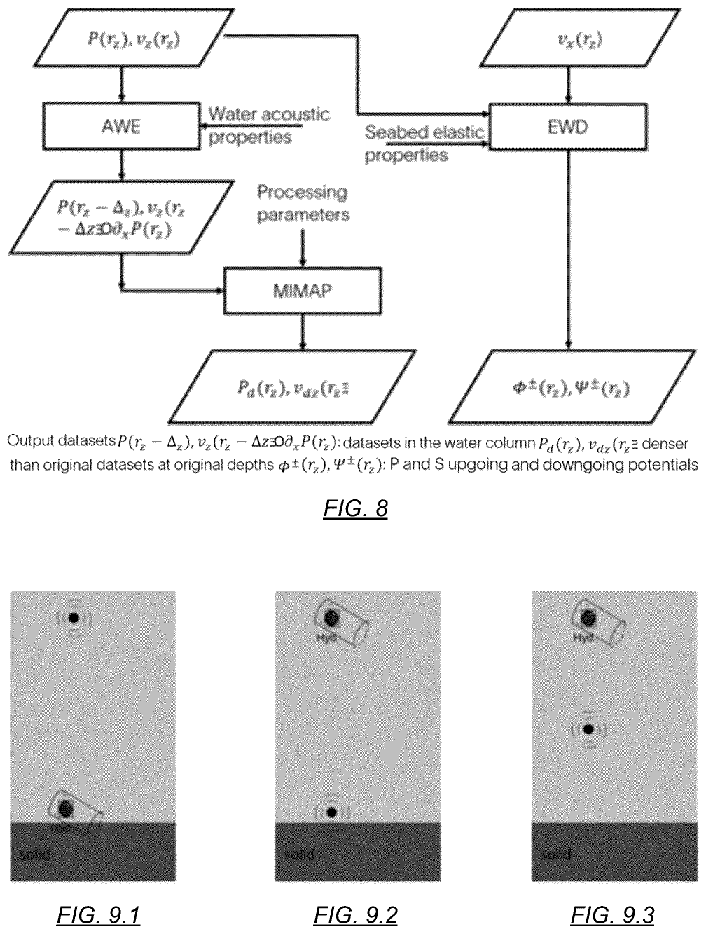

The coefficients of the extrapolation operators for the three tasks described above are determined in the domain where the sampling is denser, i.e., the common receiver gather domain. This implies that an assumption of local lateral invariance is used as explained in the detailed description of one or more embodiments. FIG. 8 is a schematic representation of the algorithms to create the three groups of virtual datasets. In particular, FIG. 8 shows a flowchart of input datasets, wave equation operators, and output datasets associated with one or more embodiments.

Each of the three groups of virtual datasets that are created with the disclosed method are generated by processing ocean bottom multi-component measurements. The measurements provide information about the seismic wavefield that enables the generation of a more accurate image of the subsurface.

In FIG. 8, the parallelograms represent input or output datasets. In FIG. 8, the rectangles represent operators. The term “AWE” means “acoustic wavefield extrapolator.” The term “EWD means “elastic wavefield decomposer.” The term “MIMAP” means “multicomponent interpolator by matching pursuit.”

The output datasets P(r_{z}−Δz), ν_{z}(r_{z}−Δ(r_{z}−Δz∃0∂ₓP(r_{z}) are datasets in the water column. The output datasets P_{d} (r_{z}), ν_{dz}(r_{z}) are denser that the original data sets at original depths. The output datasets Φ±(r_{z}),Ψ±(r_{z}) are the P and S up-going and down-going potentials. (See FIG. 8, which shows the output datasets.)

The following may be performed to determine the first group of datasets.

The determination of the first class of measurements is here described. In order to simplify the notation, the nomenclature is for 2D datasets, i.e., datasets that are functions of one horizontal spatial coordinate for both sources and receivers such as P(t, rₓ, sₓ). When the dependency on receiver depth is relevant, the notation P(r_{z}) is used. When the domain in which the algorithm operates is to be highlighted, the independent variables in that domain are explicitly written, e.g. P(ρ, ω) for the Radon-Fourier domain. The upward extrapolation of the wavefield recorded at the seabed can be expressed in matrix notation as:

$$[ \begin{matrix}P ( {r}_{z} - Δ z ) \\ {\partial }_{t} {v}_{z} ( {r}_{z} - Δ z )\end{matrix} ] = [ \begin{matrix}{W}_{1} & {W}_{2} \\ {W}_{3} & {W}_{4}\end{matrix} ] [ \begin{matrix}P ( {r}_{z} ) \\ {\partial }_{t} {v}_{z} ( {r}_{z} )\end{matrix} ] \qquad ( 1 )$$

where Wj are the coefficients of the two-way acoustic extrapolator defined in Wapenaar and Berkhout, 1986, and ∂ₜ is the time derivative.

The continuity of the vertical particle displacement implies that the particle displacement measured just underneath the seabed can be used to extrapolate the wavefield in water. Thus, FIG. 9.1, FIG. 9.2, and FIG. 9.3 are schematic representations of the acquisition configuration to record a single trace of a seabed dataset, the reciprocal experiment which may be carried out during the modeling stage of full waveform inversion and the reciprocal experiment that would be carried out using the dataset output with the disclosed method. In FIG. 9.1 through FIG. 9.3, the dots represent a pressure source and the cylinders with dots represent hydrophones.

Again, FIGS. 9.1-9.3 show schematic representations of one trace of a dataset created with the first group of measurements. FIG. 9.1 shows an actual experiment. FIG. 9.2 shows a numerical simulation carried out for full waveform inversion based model building. FIG. 9.3 shows a numerical simulation carried out for full waveform inversion based model building using the dataset created with the first method.

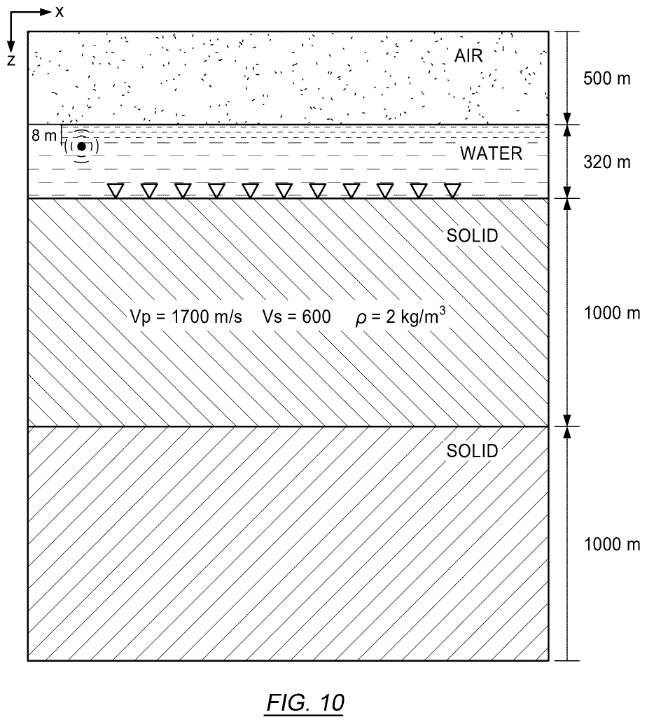

FIG. 10 shows a model for the creation of the synthetic dataset. Reflectivity modeling is in the Radon domain. The Ricker wavelet has a central frequency of 15 Hz. A receiver spacing is 12.5 m.

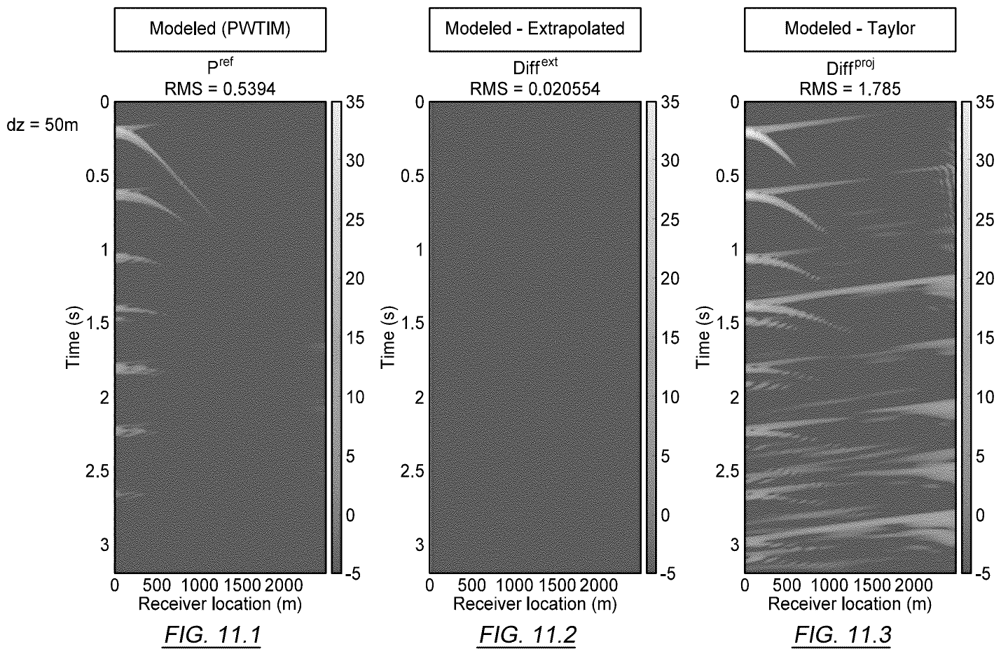

A synthetic dataset was created by reflectivity modeling using the model in FIG. 10, FIG. 11.1, FIG. 11.2, and FIG. 11.3 compares the result of applying equation (1) for the computation of the pressure wavefield with Dz=50 m, the result obtained with the first order Taylor expansion of the data measured at the seabed:

$$P ( {r}_{z} - Δ z ) = P ( {r}_{z} ) - ρΔ z {\partial }_{t} {v}_{z} ( {r}_{z} ) . \qquad ( 1 )$$

The acoustic extrapolator is a far better approximation than the Taylor series of the pressure that would have been recorded at the same depth.

FIG. 11.1-FIG. 11.3 show acoustic upward extrapolation. FIG. 11.1 shows a modeled pressure at z=270 m, i.e., 50 m above the seabed. FIG. 11.2 shows a difference between the modeled pressure and the pressure extrapolated using the two-way acoustic extrapolator. FIG. 11.3 shows a difference between the modeled pressure and the pressure obtained with the Taylor series.

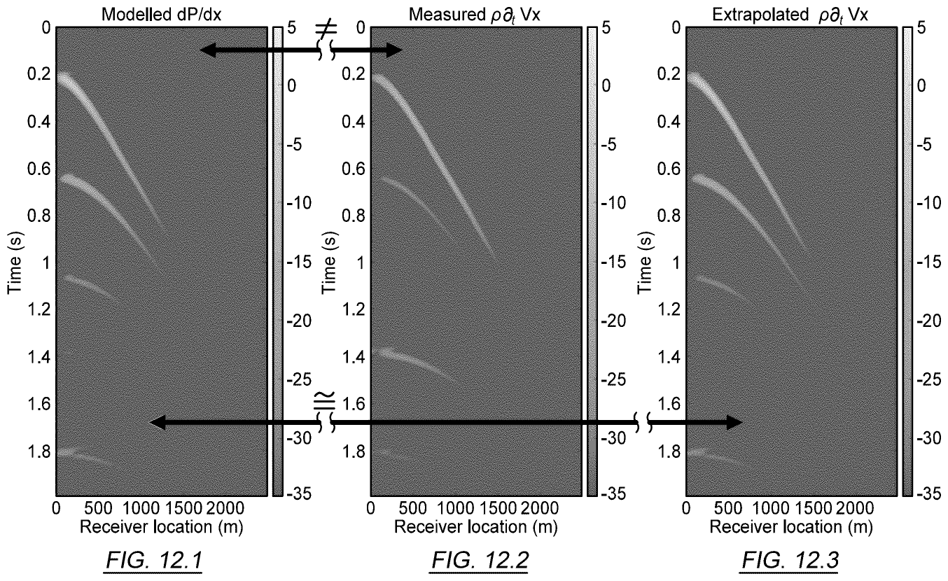

The second dataset, which is delivered in the first group of datasets, is the horizontal gradient of the pressure, or equivalently, the horizontal particle velocity above the seabed. FIG. 12.1, FIG. 12.2, and FIG. 12.3 demonstrate that the measured horizontal particle velocity cannot be used as proxy for the horizontal gradient, whereas the horizontal particle velocity after upward extrapolation is very similar to the modeled particle velocity at the same depth.

In particular, FIG. 12.1-FIG. 12.3 show the horizontal gradient of the pressure just above the seabed. FIG. 12.1 shows the modeled gradient. FIG. 12.2 shows a density-scaled version of the measured horizontal acceleration. FIG. 12.3 shows a density-scaled version of the upward horizontal acceleration after upward extrapolation of the measured data.

Attention is now turned to the second method (Method 2) to deliver second group of datasets.

The horizontal gradient of the pressure extrapolated above the seabed along with the measured pressure are the input to an interpolation method. These methods are used to either interpolate to a denser and regular grid or to extrapolate the data in nearby original receiver locations.

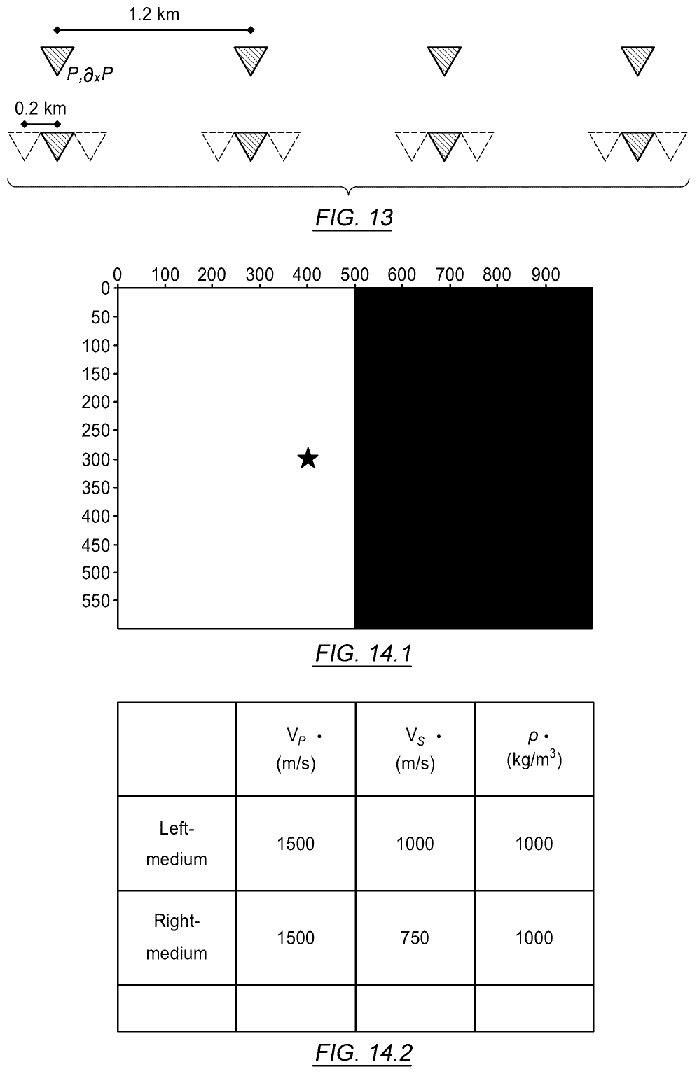

FIG. 13 shows the creation of a dataset of the second group using horizontal pressure gradients determined with Method 1. The signals from the receivers at the original locations [0 1.2 2.4. 3.6] km (kilometers) are laterally extrapolated to [−0.2 0.2 1.0 1.4 2.2 2.6. 3.4 3.6] km. The extrapolated and original data can then be used as they are re-gridded to a desired grid denser than the original one, e.g., with 1 km spacing.

Attention is now turned to a third method (Method 3) to deliver the third group of datasets, which is approximating the elastic effects on the propagation of compressional waves.

It may be desirable to carry out simulations that model the amplitudes of compressional waves considering the elastic effects; e.g., acoustic amplitude-versus-angle (AVA). Acoustic AVA does not model mode conversions. Acoustic AVA (when tuned for the reflections) makes the amplitudes of the compressional wave reflections a better approximation of those that would have been obtained with elastic modeling. However, the transmitted amplitudes of the compressional waves are modified as well. Consequently, the amplitudes of the transmitted compressional waves obtained with acoustic AVA are not necessarily a better approximation than those obtained with acoustic modeling.

FIG. 14.1 shows a half-space experiment. The half-space experiment is a simplified model where an infinite volume of material lies beneath a flat surface, above which no signal can travel. The model is used to study the behavior of geophysical signals and their interactions with subsurface structures.

FIG. 14.2 shows the elastic properties of the two media in FIG. 14.1. The source is located 100 m away from the interface.

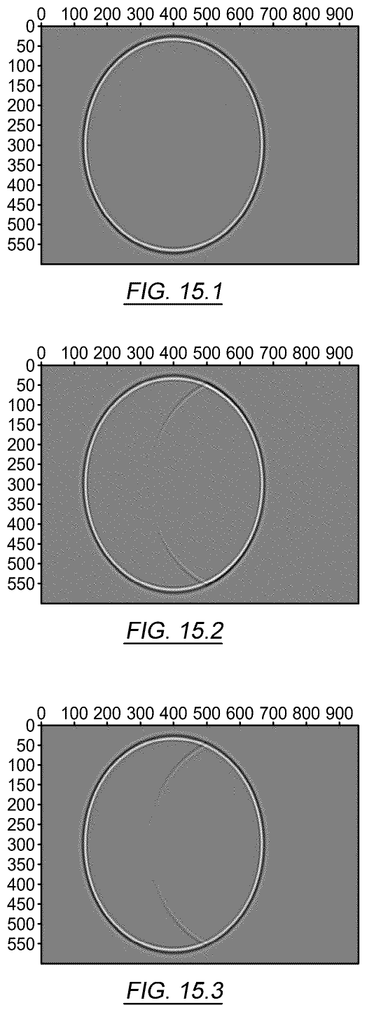

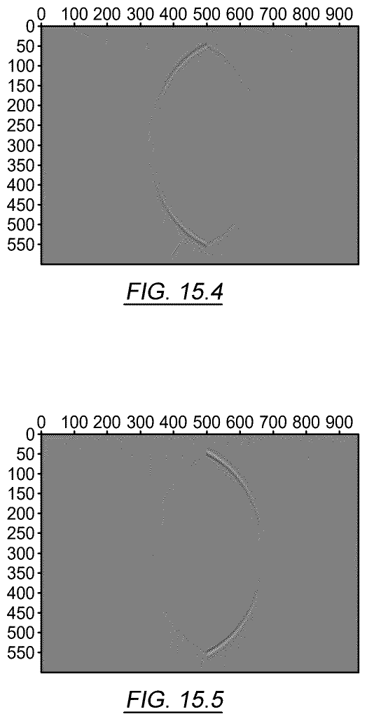

FIG. 15.1 through FIG. 15.5 show examples that confirms that acoustic AVA is a better approximation of the compressional reflections, relative to acoustic modelling. FIG. 15.1 through FIG. 15.5 show the accuracy of acoustic AVA modeling for the model shown in FIG. 14.1.

For computational efficiency, acoustic or elastic full waveform inversion in seabed surveys may be carried out with a reciprocal approach in which virtual sources are located in the proximity to the seabed. The capability to re-datum the recorded wavefield in an OBN survey from the actual location to a location further up in the water column, which is disclosed here, mitigates the limitation of acoustic AVA in deep-water seabed surveys because sources far from the seabed do not generate interface waves.

FIG. 15.1 shows the acoustic accuracy. FIG. 15.2 shows the acoustic AVA accuracy. FIG. 15.3 shows the elastic accuracy. FIG. 15.4 shows the elastic minus acoustic accuracy. FIG. 15.5 shows the S wave elastic minus acoustic AVA accuracy.

Attention is now turned to determining P and S potentials.

A multicomponent dataset acquired at the seabed in the up-going and down-going P and S potentials of the wavefield below the seabed may be transformed. A useful step is the elastic wavefield decomposition below the seabed that in Radon (frequency-slowness) domain is implemented with the two equations.

$$- {τ}_{zz}^{\pm } ( p , ω ) = \frac{1}{2} P ( p , ω ) \pm \frac{{ρ}_{1} {β}_{1} ( p )}{2 {q}_{P , 1} ( p )} {v}_{z} ( p , ω ) \qquad ( 3 )$$

$$and$$

$$- {τ}_{xz}^{\pm } ( p , ω ) = \pm \frac{p {γ}_{1} ( p )}{2 {q}_{S , 1} ( p )} P ( p , ω ) \pm \frac{{ρ}_{1} {β}_{1} ( p )}{2 {q}_{S , 1} ( p )} {V}_{x} ( p , ω ) , \qquad ( 4 )$$

In equations (3) and (4), the T_{zz} is the normal stress below the seabed, τ_{xz} is the shear stress below the seabed, ρ₁ is the density below the seabed, q_{P,1}(q_{S.1}) is the P(S) wave vertical slowness below the seabed, β₁(φ and γ₁(φ are frequency-independent functions of the P and S wave velocities. The superscripts + and − denote the down-going and up-going propagating wavefields respectively. Equation (4) highlights that the total shear stress below the seabed is null but the shear stresses of the up-going and down-going wavefield are not. The wavefields decomposed in normal and shear stress do contain a mixture of P and S waves. The decomposition of them into the P and S potentials decouples these parts of the wavefield is:

$${Φ}^{\pm } ( p , ω ) = \frac{{c}_{S , 1}^{2}}{{β}_{1} ( p )} \{ ∓ 2 {pq}_{S , 1} ( p ) {τ}_{xz}^{\pm } ( p , ω ) - ( {c}_{S , 1}^{- 2} - 2 {p}^{2} ) {τ}_{zz}^{\pm } ( p , ω ) \} , \qquad ( 5 )$$

$$and$$

$${Ψ}^{\pm } ( p , ω ) = \frac{{c}_{S , 1}^{2}}{{β}_{1} ( p )} \{ ( {c}_{S , 1}^{- 2} - 2 {p}^{2} ) {τ}_{xz}^{\pm } ( p , ω ) ∓ 2 {pq}_{P , 1} ( p ) {τ}_{zz}^{\pm } ( p , ω ) \} , \qquad ( 6 )$$

where Φ and Ψ are the P and S potentials respectively.

Attention is now turned to enhancements and assumptions for using full waveform inversion without increasing the computational cost.

Separate modeling of pressure and pressure gradients (or dipole) increases the full waveform inversion computational cost. Simultaneous numerical simulation of the monopole and the dipoles is an appealing alternative. The composed wavefield will be more energetic than a monopole wavefield at the large take-off angles of interest for model building using the full waveform inversion method. The wavefield obtained from vertical propagation, which is generally affected by internal multiples, will be less energetic and therefore will give rise to a better balanced full waveform inversion cost function. Full waveform inversion is an iterative process. Alternative modeling of monopole and dipole sources at successive iterations will retain the computational costs or, if convergence is sped up, will reduce it.

Attention is now turned to coarse sampling in a shot gather domain.

In order to extrapolate actual pressure and particle velocity estimates measurements to virtual hydrophones in water, the extrapolator may be applied to common shot gathers. OBS surveys may be densely sampled in common receiver gather domain but coarsely sampled in shot gather domain. An assumption may be made that the partial derivatives of the pressure with respect to the receiver location are identical to those with respect to the source location. This approximation can be better understood by considering the two-point finite-difference approximation of the desired gradient, i.e., considering for the sake of simplicity the x and z axes:

$$\frac{P ( {r}_{x} + Δ {r}_{x} , {s}_{x} ; - Δ z ) - P ( {r}_{x} , {s}_{x} ; - Δ z )}{Δ {r}_{x}} ≅ \frac{P ( {r}_{x} , {s}_{x} - Δ {r}_{x} ; - Δ z ) - P ( {r}_{x} , {s}_{x} ; - Δ z )}{Δ {r}_{x}} \qquad ( 7 )$$

Notice that the increment in the source location in the two-point finite-difference approximation has the opposite sign to that of the receiver location.

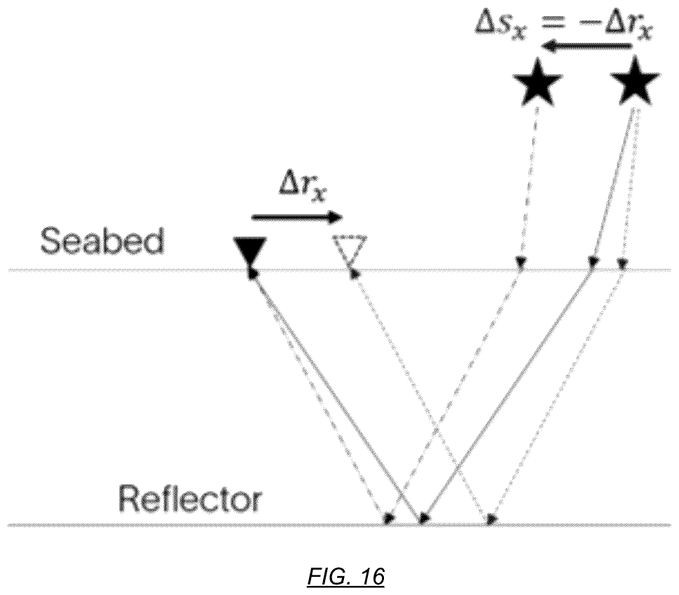

FIG. 16 is a schematic representation of the proposed approach to obtain the traces used to estimate the gradient (with respect to the receiver position) in the presence of a sparse grid of receivers. Obtaining the traces may not use a transform of the data in the Radon domain because the obtained traces are based on borrowing traces from the densely sampled source grid. FIG. 16 also may be characterized as a schematic representation of the lateral invariance assumption to apply one or more embodiments to OBS data sparsely sampled on the receivers.

In FIG. 16, the stars represent existing shots (i.e., generated acoustic wave bursts). The solid inverted triangles represent existing receivers. The empty inverted triangles represent missing receivers at desired locations (for which virtual data is generated using one or more embodiments disclosed herein). Solid arrows represent existing (real) acoustic wave propagations. The dot-dashed lines represent borrowed acoustic wave propagations. The dashed lines represent desired, but missing acoustic wave propagations. The term Δrₓ represents a change in distance. The term Sₓ represents a change in S waves.

The expected uplift obtainable from these three groups of datasets is as follows. The advantages of Group 1 of measurements can be understood bearing in mind that, for computational reasons, the forward modeling component of model building based on (elastic) full waveform inversion (full waveform inversion) is carried out using reciprocity, i.e., the pressure source is located at the hydrophone location and the hydrophone is located at the geophysical center of the source array.

A monopole pressure source located close to the seabed generates Scholte waves. Numerical simulations use dense spatial sampling in order to properly model these slow waves. The generation of a hydrophone measurement in the water column away from the seabed enables numerical simulations without the dense sampling used to properly propagate Scholte waves. In the actual experiment, Scholte waves are not measured in deep water because the actual source, which is in the proximity of the sea surface, does not excite them.

A further advantage of a virtual source away from the seabed is that the “injection” of the source wavefield in finite difference modeling does not suffer from the averaging of the elastic properties of two media (seawater and seabed) that have very different elastic properties. The capability to extrapolate the wavefield in the middle of the water column also enables the creation of dipoles whose radiation pattern can be tuned to, for instance, emit more energy towards the long offsets that are useful for model building. Lack of illumination during the actual acquisition are not compensated with the disclosed method but the virtual dataset emphasizes parts of the wavefield that are more useful for the estimation of the subsurface elastic model.

A scalar wavefield such as the P potential is a purified version of the recorded wavefield, which is actually recorded. The untangled P and S waves are a better starting point for elastic full waveform inversion. However, it should be noted that elastic effects that take place in the overburden and in the deeper part of the subsurface will nevertheless affect the P and S potentials. In other words, the P potential is not the scalar wavefield that would have been recorded if P to S mode conversions in the deep subsurface had not occurred.

The foregoing description, for purpose of explanation, has been described with reference to specific embodiments. However, the illustrative discussions above are not intended to be exhaustive or to limit one or more embodiments to the precise forms disclosed. Many modifications and variations are possible in view of the above teachings. The embodiments were chosen and described in order to explain the principles of one or more embodiments and their practical applications, to thereby enable others skilled in the art to utilize one or more embodiments and various embodiments with various modifications as are suited to the particular use contemplated.

One or more embodiments may be characterized as a method. The method includes receiving multi-component seismic data acquired at the water bottom interface during a seismic acquisition. The method also includes processing the received data with a computer to obtain one or more of the following virtual datasets: extrapolated wavefield above the seabed in the proximity of the receivers, spatial gradient of the pressure wavefield at the receivers, and/or potentials of the received (i.e., measured) wavefield below the seabed. The method also includes processing the virtual datasets with computers to obtain an image of the subsurface and/or an estimate of its physical properties.

In an embodiment, the multi-component measurements may include the pressure wavefield and the three-component particle motion (or velocity, or acceleration) wavefield, or a subset of those. In another embodiment, the extrapolated wavefield comprises simulating a vertical or a horizontal dipole wavefield in the proximity of the receivers. The proximity of the receivers may include distances in the range of 0-100 m, or similar distances.

In one or more embodiments, the processing of the spatial gradients of the wavefield may include performing multi-channel interpolation, or joint interpolation, and de-ghosting. In one or more embodiments, the processing of the virtual datasets may include applying elastic full wavefield inversion technology.

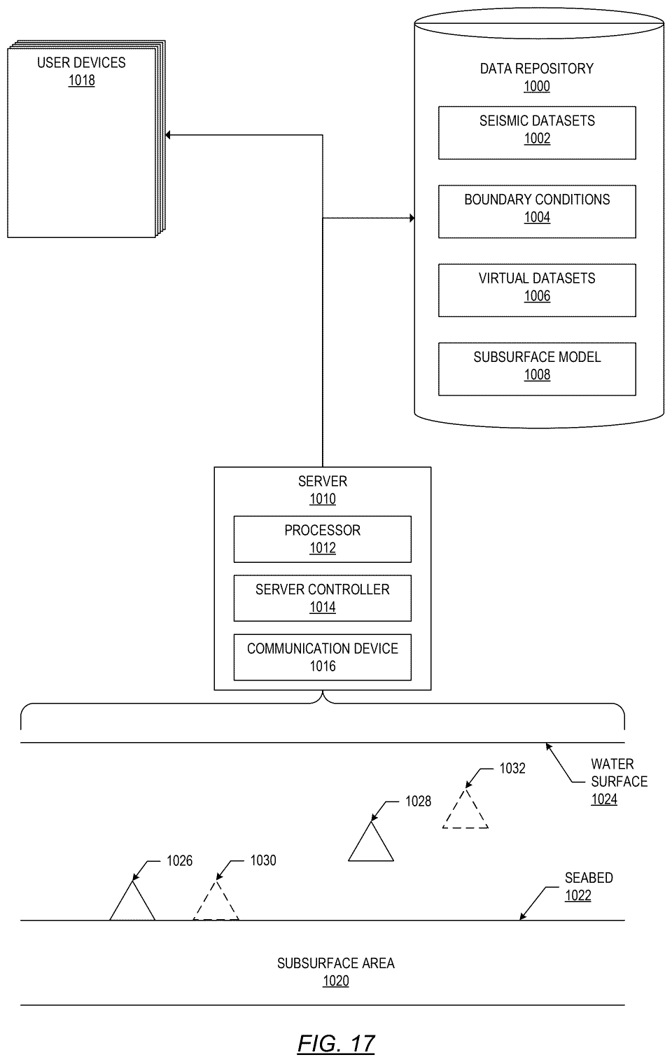

Attention is now turned to the figures. FIG. 17 shows a computing system, in accordance with one or more embodiments. The computing system shown in FIG. 17 includes a data repository (1000) storing seismic datasets (1002), boundary conditions (1004), virtual datasets (1006), and subsurface model (1008), all described below. The computing system shown in FIG. 17 also includes a server (1010) including a processor (1012), a server controller (1014), and a communication device (1016). The computing system shown in FIG. 17 also may include one or more user devices (1018) used to communicate with the server (1010) or the data repository (1000).

The computing system shown in FIG. 17 operates in the context of a physical area, including a subsurface area (1020) bounded on an upper surface formed by a seabed (1022). A layer of water (e.g., ocean water) is disposed above the processor (1012). The layer of water is bounded on an upper surface formed by the water surface (1024).

A number of seismic sensors are disposed on the seabed (1022) or in the water beneath the water surface (1024). The seismic sensors include real seismic sensors, including real sensor 1 (1026) and real sensor 2 (1028). The real seismic sensors take real seismic data in the form of measurements of pressure, density, and velocity changes in ground (in the case of the real sensor 1 (1026)) or in the water (in the case of the real sensor 2 (1028)). The real seismic sensors also may be associated with seismic emitters (e.g., thumpers on the ground or hydrophones in the water). The real seismic sensors or emitters may be in wired or wireless communication with the server (1010), which may store seismic data in the data repository (1000).

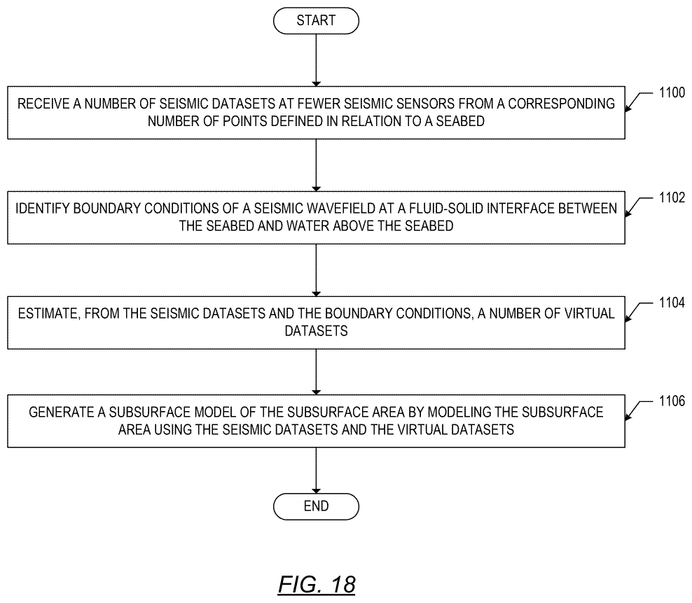

The seismic sensors also include virtual seismic sensors, such as virtual sensor 1 (1030) and virtual sensor 2 (1032). The virtual seismic sensors do not exist in the real environment shown in FIG. 17. However, knowing the distance between the real seismic sensors and the points at which the corresponding locations at which the virtual seismic sensors are located, and further knowing how waves travel in the ground or in the water, the real seismic data may be used to estimate what data might have been collected at the locations identified for the virtual seismic sensors. Thus, each location may be referred to as a virtual seismic sensor for which virtual data may be estimated from the real seismic data, as described above and as further described with respect to FIG. 18.

Attention is now returned to the system shown in FIG. 17. The system of FIG. 17 may be characterized as a system for seabed seismic processing for elastic full waveform inversion. The system of FIG. 17 also may be characterized as a system for modeling a subsurface area of a seabed using fewer seismic sensors than a number of the seismic sensors that would generate sufficient data to permit a desired model of the subsurface area.

The system includes a data repository (1000). The data repository (1000) is a type of storage unit or device (e.g., a file system, database, data structure, or any other storage mechanism) for storing data. The data repository (1000) may include multiple different, potentially heterogeneous, storage units and/or devices.

The data repository (1000) stores one or more seismic datasets (1002). The seismic datasets (1002) include data measured from one or more real sensors, such as the real sensor 1 (1026) and the real sensor 2 (1028). The seismic datasets (1002) may be stored together or as discrete datasets associated with each of the real seismic sensors. The seismic datasets (1002) may include information such as location, depth, density, viscosity, particle velocity, wavelength, wave amplitude, and other information of interest useful for modeling the subsurface area (1020).

The data repository (1000) also stores one or more boundary conditions (1004). The boundary conditions (1004) represent the physical laws that govern wave propagation between a real sensor (e.g., the real sensor 1 (1026)) and a corresponding virtual sensor (e.g., the virtual sensor 1 (1030)). The types of the boundary conditions (1004), and methods for manipulating the boundary conditions (1004), are described above with respect to FIG. 8 through FIG. 16.

The data repository (1000) also stores one or more virtual datasets (1006). The virtual datasets (1006) are datasets derived from the seismic datasets (1002) using the boundary conditions (1004). Each of the virtual datasets (1006) therefore is data that might have been taken at one of the locations of the virtual sensors (e.g., virtual sensor 1 (1030)), had a real sensor been placed at the virtual sensor location. Thus, while the virtual datasets (1006) do not represent real data, the virtual datasets (1006) nevertheless may be accurate enough to generate sufficient additional data that permits modeling of the subsurface area (1020) to the desired degree of accuracy.

The data repository (1000) also stores a subsurface model (1008). The subsurface model (1008) is a model of the subsurface area (1020). The subsurface model (1008) is generated using a combination of the seismic datasets (1002) and the virtual datasets (1006). The subsurface model (1008) may be generated using full waveform inversion. The subsurface model (1008) may be generated using another modeling technique in other embodiments.

The system shown in FIG. 17 may include other components. For example, the system shown in FIG. 17 also may include a server (1010). The server (1010) is one or more computer processors, data repositories, communication devices, and supporting hardware and software. The server (1010) may be in a distributed computing environment. The server (1010) is configured to execute one or more applications, such as the server controller (1014). An example of a computer system and network that may form the server (1010) is described with respect to FIG. 1.

The server (1010) includes a computer processor (1012). The computer processor (1012) is one or more hardware or virtual processors which may execute computer-readable program code that defines one or more applications, such as the server controller (1014). An example of the computer processor (1012) is described with respect to the computer processor(s) of FIG. 1.

The server (1010) also may include a server controller (1014). The server controller (1014) is software or application specific hardware which, when executed by the computer processor (1012), controls and coordinates operation of the software or application specific hardware described herein. The server controller (1014) may execute the method of FIG. 8. The server controller (1014) also may control and coordinate operation of the communication device (1016).

The system shown in FIG. 17 also may include one or more user devices (1018). The user devices (1018) are computing systems (e.g., the computing system shown in FIG. 1) that communicate with the server (1010).

The user devices (1018) may be considered remote or local. A remote user device is a device operated by a third-party (e.g., an end user of a chatbot) that does not control or operate the system of FIG. 17. Similarly, the organization that controls the other elements of the system of FIG. 17 may not control or operate the remote user device. Thus, a remote user device may not be considered part of the system of FIG. 17.

In contrast, a local user device is a device operated under the control of the organization that controls the other components of the system of FIG. 17. Thus, a local user device may be considered part of the system of FIG. 17.

While FIG. 17 shows a configuration of components, other configurations may be used without departing from the scope of one or more embodiments. For example, various components may be combined to create a single component. As another example, the functionality performed by a single component may be performed by two or more components.

FIG. 18 shows a method for seabed seismic processing for elastic full waveform inversion, in accordance with one or more embodiments. The method of FIG. 18 also may be characterized as a method of modeling a subsurface area of a seabed using fewer seismic sensors than a number of the seismic sensors that would generate sufficient data to permit a desired model of the subsurface area. The method of FIG. 18 may be implemented using the system of FIG. 8 and one or more of the steps may be performed on or received at one or more computer processors.

Step 1100 includes receiving a number of seismic datasets from the fewer seismic sensors, the fewer seismic sensors located at a number of points defined in relation to the seabed. The fewer seismic sensors are reason seismic sensors. Thus, the seismic datasets are real datasets. The seismic datasets may be received via communication devices in communication with one or more real seismic sensors.

Step 1102 includes identifying boundary conditions of a seismic wavefield at a fluid-solid interface between the seabed and water above the seabed. The boundary conditions may be identified based on the type of virtual datasets that are desired. For example, if the virtual dataset estimated at step 1104, below, is pressure and particle velocity estimates at the virtual sensor location, then the two-way acoustic extrapolator may be applied to the particle velocity normal to the seabed local plane and to the pressure measured at the seabed, as described with respect to FIG. 8 or FIG. 17.1 through FIG. 17.3. Similarly, if other types of virtual datasets are desired, as described with respect to FIG. 8 through FIG. 16, then the appropriate boundary conditions (e.g. equations described above) may be selected for a given type of virtual dataset.

Step 1104 includes estimating, from the number of seismic datasets and the boundary conditions, a number of virtual datasets. Each of the number of virtual datasets includes corresponding estimated data for an additional number of points defined in relation to the seabed. The number of points and the additional number of points, combined, are sufficient to permit the desired model of the subsurface area.

The virtual datasets may be generated from the boundary conditions (e.g., equations) applied to the real datasets based on a distance from a given real sensor to a given virtual sensor. Thus, for example, the virtual datasets may include pressure and particle velocity estimates and corresponding spatial derivatives thereof in a column in the water. The virtual datasets may include a dense dataset including additional seismic datasets representing estimated data taken by additional virtual seismic sensors. The virtual datasets may include P and S wavefield potentials below the seabed taken by additional virtual seismic sensors. The virtual datasets may include a combination of two or more of: a) pressure and particle velocity estimates and corresponding spatial derivatives thereof in a column in the water, b) a dense dataset including additional seismic datasets representing estimated data taken by additional virtual seismic sensors, and c) P and S wavefield potentials below the seabed taken by further additional virtual seismic sensors. The virtual datasets further may include at least one of: an extrapolated wavefield above the seabed in proximity to receiver sensors, a spatial gradient of a pressure wavefield at the number of sensors, and a potential of a received wavefield below the seabed.

In any case, the virtual datasets are derived from a combination of measurements taken by ocean bottom seismometers and seismic measurements taken in the water, up to proximity of the sea surface. The derivation is based on the boundary conditions that apply to a given type of virtual dataset.

Step 1106 includes generating a subsurface model of the subsurface area by modeling the subsurface area using the number of seismic datasets and the number of virtual datasets. Generation of the subsurface model may be performed using full waveform inversion as applied to the combination of the real datasets and virtual datasets. Generation of the subsurface model may be performed using other modeling techniques. The computational efficiency of generating the subsurface model may be increased by setting virtual sources of the virtual datasets in proximity to the seabed. Thus, one or more embodiments may increase the computational efficiency of a computer when modeling the subsurface area.

In an embodiment, generating the subsurface model may include generating an image of the subsurface area, estimating a physical property of the subsurface area, or a combination thereof. Generating the subsurface model may include generating instructions for performing a drilling operation at the subsurface area in order to maximize an efficiency, a production, or both an efficiency and production of a natural resource production from the subsurface area. Generating the subsurface model may include indicating areas of natural resources within the subsurface area, or may show subsurface formations within the subsurface area.

The method of FIG. 18 may be varied. For example, the method also may include controlling, according to the subsurface model, a drill penetrating the subsurface area. For example, the drill speed may be controlled to a selected speed that is optimized to penetrate a specific type of rock or other material encountered within the subsurface area. In another example, the drill angle may be changed or the diameter of the wellbore may be changed. Other aspects of the drill operation likewise may be changed in response to information presented in the subsurface model.

In another variation to FIG. 18, other methods are possible. For example, one or more embodiments provide for a method of controlling a drilling operation at a subsurface area of a seabed using a subsurface model of the subsurface area generated using fewer seismic sensors than a number of seismic sensors that generate sufficient data to permit a desired subsurface model of the subsurface area. The method includes receiving a number of seismic datasets from the fewer seismic sensors, the fewer seismic sensors located at a number of points defined in relation to the seabed. The method also includes identifying boundary conditions of a seismic wavefield at a fluid-solid interface between the seabed and water above the seabed. The method also includes estimating, from the number of seismic datasets and the boundary conditions, a number of virtual datasets. Each of the number of virtual datasets includes corresponding estimated data for an additional number of points defined in relation to the seabed. The number of points and the additional number of points, combined, are sufficient to permit the desired subsurface model of the subsurface area. The method also includes generating the subsurface model of the subsurface area by modeling the subsurface area using the number of seismic datasets and the number of virtual datasets. The method also includes controlling, according to the subsurface model, a drill while drilling at the subsurface area. In one or more embodiments, controlling the drill may include at least one of: selecting, based on the subsurface model, a specific drilling location at which to operate the drill and operating the drill at the specific drilling location, selecting, based on the subsurface model, a speed at which to operate the drill, selecting, based on the subsurface model, an angle at which to dig a borehole with the drill into the subsurface area, and combinations thereof.

While the various steps in the flowchart of FIG. 18 are presented and described sequentially, at least some of the steps may be executed in different orders, may be combined or omitted, and at least some of the steps may be executed in parallel. Furthermore, the steps may be performed actively or passively.

In the application, ordinal numbers (e.g., first, second, third, etc.) may be used as an adjective for an element (i.e., any noun in the application). The use of ordinal numbers is not to imply or create any particular ordering of the elements, nor to limit any element to being one element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited by the attached claims.

What is claimed is:

1. A method of modeling a subsurface area of a seabed using fewer seismic sensors than a number of seismic sensors that generate sufficient data to permit a desired model of the subsurface area, the method comprising:
receiving a plurality of seismic datasets from the fewer seismic sensors, the fewer seismic sensors located at a plurality of points defined in relation to the seabed;
identifying boundary conditions of a seismic wavefield at a fluid-solid interface between the seabed and water above the seabed;
estimating, from the plurality of seismic datasets and the boundary conditions, a plurality of virtual datasets, wherein:
each of the plurality of virtual datasets comprises corresponding estimated data for an additional plurality of points defined in relation to the seabed, and
the plurality of points and the additional plurality of points, combined, are sufficient to permit the desired model of the subsurface area; and
generating a subsurface model of the subsurface area by modeling the subsurface area using the plurality of seismic datasets and the plurality of virtual datasets.

2. The method of claim 1, wherein the plurality of virtual datasets include pressure and particle velocity estimates and corresponding spatial derivatives thereof in a column in the water.

3. The method of claim 1, wherein the plurality of virtual datasets include a dense dataset comprising additional seismic datasets representing estimated data taken by additional virtual seismic sensors.

4. The method of claim 1, wherein the plurality of virtual datasets include P and S wavefield potentials below the seabed taken by additional virtual seismic sensors.

5. The method of claim 1, wherein the plurality of virtual datasets include a combination of: a) pressure and particle velocity estimates and corresponding spatial derivatives thereof in a column in the water, b) a dense dataset comprising additional seismic datasets representing estimated data taken by additional virtual seismic sensors, and c) P and S wavefield potentials below the seabed taken by further additional virtual seismic sensors.

6. The method of claim 5, wherein the plurality of virtual datasets are derived from a combination of measurements taken by ocean bottom seismometers and seismic measurements taken in the water, up to proximity of a sea surface.

7. The method of claim 1, wherein generating the subsurface model is performed using full waveform inversion.

8. The method of claim 7, further comprising:
increasing a computational efficiency of generating the subsurface model by setting virtual sources of the virtual datasets in proximity to the seabed.

9. The method of claim 1, wherein the plurality of virtual datasets further comprise at least one of: an extrapolated wavefield above the seabed in proximity to receiver sensors; a spatial gradient of a pressure wavefield at the plurality of sensors; and a potential of a received wavefield below the seabed.

10. The method of claim 1, wherein generating the subsurface model comprises performing at least one of: generating an image of the subsurface area and estimating a physical property of the subsurface area.

11. The method of claim 1, further comprising:
controlling, according to the subsurface model, a drill penetrating the subsurface area.

12. A system for modeling a subsurface area of a seabed using fewer seismic sensors than a number of seismic sensors that generate sufficient data to permit a desired model of the subsurface area, the system comprising:
a computer processor;
a plurality of seismic sensors, wherein the plurality of seismic sensors comprises the fewer seismic sensors, and wherein the plurality of seismic sensors are located at a plurality of points defined in relation to the seabed;
a data repository in communication with the computer processor and storing:
a plurality of seismic datasets,
boundary conditions of a seismic wavefield at a fluid-solid interface between the seabed and water above the seabed,
a plurality of virtual datasets wherein each of the plurality of virtual datasets comprises corresponding estimated data for an additional plurality of points defined in relation to the seabed, and
a subsurface model; and
a server controller executable by the computer processor to:
receive the plurality of seismic datasets from the plurality of seismic sensors,
identify the boundary conditions,
estimate, from the plurality of seismic datasets and the boundary conditions, the plurality of virtual datasets, wherein the plurality of points and the additional plurality of points, combined, are sufficient to permit the desired model of the subsurface area, and
generate the subsurface model of the subsurface area by modeling the subsurface area using the plurality of seismic datasets and the plurality of virtual datasets.

13. The system of claim 12, wherein the plurality of virtual datasets include a combination of at least one of: a) pressure and particle velocity estimates and corresponding spatial derivatives thereof in a column in the water, b) a dense dataset comprising additional seismic datasets representing estimated data taken by additional virtual seismic sensors, and c) P and S wavefield potentials below the seabed taken by further additional virtual seismic sensors.

14. The system of claim 12, wherein generating the subsurface model is performed using full waveform inversion.

15. The system of claim 14, wherein the server controller is further executable by the computer processor to:
increase a computational efficiency of generating the subsurface model by setting virtual sources of the virtual datasets in proximity to the seabed.

16. The system of claim 12, further comprising:
a plurality of ocean bottom seismometers; and
seismic hydrophones,
wherein the plurality of virtual datasets are derived from a combination of measurements taken by the plurality of ocean bottom seismometers and seismic measurements taken in the water by the seismic hydrophones, up to proximity of a sea surface.

17. The system of claim 12, wherein the plurality of virtual datasets further comprise at least one of: an extrapolated wavefield above the seabed in proximity to receiver sensors; a spatial gradient of a pressure wavefield at the plurality of sensors; and a potential of a received wavefield below the seabed.

18. The system of claim 12, wherein generating the subsurface model comprises performing at least one of: generating an image of the subsurface area and estimating a physical property of the subsurface area.
